(19) United States
(12) Patent Application Publication
(10) Pub. No.: US 2011/0186492 A1
(43) Pub. Date: Aug. 4, 2011

(54) Stormwater treatment system with two chamber treatment container and overflow tray

(76) Inventor: James Ferguson Holtz, Portland, OR (US)

(21) Appl. No.: 12/929,447

(22) Filed: Jan. 26, 2011

Related U.S. Application Data
(60) Provisional application No. 61/282,366, filed on Jan. 28, 2010.

(51) Int. Cl. C02F 1/00; C02F 103/00

(52) U.S. Cl. 210/170.03

(57) ABSTRACT

A stormwater treatment system having a treatment container with two chambers, a treatment chamber and a bypass chamber. The bypass chamber includes an inlet for receiving stormwater. Disposed adjacent the inlet is an overflow tray secured to the walls of the bypass chamber. The tray includes an inlet opening for receiving the stormwater to be treated, and a discharge opening through the baffle wall that separates the two chambers for discharging stormwater that enters at low flow rates. The stormwater to be treated passes through the discharge opening into the treatment chamber where it is treated by the filter media. High flow rates will bypass the treatment chamber by overflowing a dam wall or weir defined by the overflow tray directly into the bypass chamber. Treated water from the treatment chamber passes through an underdrain pipe that enters into the bypass chamber. All water from the bypass chamber exits through pipe openings, preferably on each of three sides of the bypass chamber wall.

### RELATED APPLICATION

This is a complete application of provisional application U.S. Ser. No. 61/282,366 filed Jan. 28, 2010, and hereby claims the priorities thereto to which it is entitled.

### BACKGROUND OF THE INVENTION

1. Field of the Invention

A stormwater filtration system having overflow/bypass capability forms the subject of the present invention. The stormwater filtration system includes a two chamber treatment container with a filter media that treats stormwater runoff through bioretention. Bioretention is the filtering of stormwater runoff through a terrestrial aerobic plant/soil/microbe complex to capture, remove, and cycle pollutants. The container includes a treatment chamber and a bypass chamber. A flow distribution overflow tray is positioned within the bypass chamber. The container receives stormwater through an inlet, such as a curb inlet, into the overflow tray that is positioned within the bypass chamber. Treatment flow is directed from the overflow tray into the treatment chamber. High flows of untreated stormwater overflow from the tray to the bypass chamber thereby bypassing the treatment chamber.

2. Description of the Related Art

Stormwater bioretention treatment systems are known in the art. Such systems are described in U.S. Pat. Nos. 6,277,274 and 6,569,321, exclusively licensed to the assignee of this application, and incorporated herein in their entirety by reference. Such systems have been commercialized by Americast, Inc. and marketed under the FILTERRA® trademark. Further details of the FILTERRA® system may be obtained from the Americast, Inc. website at www.filterra.com. There, an article entitled “An Advanced Sustainable Stormwater Treatment System” authored by Larry S. Coffman and Terry Siviter is available that further describes a prior art FILTERRA® system. The article is also incorporated by reference herein.

The prior FILTERRA® system includes a substantially water impermeable treatment container having an underdrain pipe embedded near the bottom of the container. The container contains filter media, including a layer of mulch overlying a soil mixture. Live plants grow in the filter media and extend out through a top opening. The container is positionable below ground (albeit could be at, or above ground level) and typically located adjacent a roadway or parking lot where flow can occur through a cutout in the curb or otherwise through the filter media. Stormwater runoff from the roadway collects pollutants which are treated in the container. The underdrain pipe is connected to an outlet that flows into the storm sewer drainage system or a separate or adjacent infiltration system, either directly or first through a catch basin. High flow rates may bypass the treatment container and may be channeled directly to a catch basin through a separate curb inlet downstream of the curb inlet for the treatment container.

Treatment of stormwater runoff at high flow rates poses known problems. When the flow rates are high, in excess of the capacity of the stormwater treatment container, the excess capacities may simply overflow the treatment container. Thus, a need has arisen to permit high stormwater runoff to overflow or bypass the treatment container filtration media in a controlled manner.

One such solution for treating runoff from building roof drains and for treating high stormwater runoffs is described in commonly-owned U.S. Pat. No. 7,425,261, issued on Sep. 16, 2008, incorporated by reference herein. Several bypass arrangements are described including a bypass arrangement for a two chamber treatment container. Stormwater to be treated enters the treatment container and high flows may bypass and go into a separate bypass chamber. See also U.S. Pat. No. 7,625,485, a divisional of the '261 patent.

Another solution for treating runoff, particularly from building roof drains, is described in patent application Ser. No. 12/379,338 entitled “Stormwater Treatment System With Flow Distribution Overflow/Bypass Tray” filed on Feb. 19, 2009, having the same inventor and assignee of the present application, now U.S. Pat. No. 7,833,412, issued on Nov. 16, 2010. This patent describes a treatment container having a single treatment chamber whereby water to be treated enters into a corner of the treatment chamber and into a flow distribution tray connected to the container side wall. The flow distribution tray includes a dam or weir wall that defines a stormwater distribution compartment including channels that open to deposit the stormwater onto the top of the filter media. High flows bypass into an overflow/bypass compartment and then through a pipe that goes to the storm sewer system or to catch basins without treatment by the filter media. This patent is incorporated by reference herein.

### SUMMARY OF THE INVENTION

The present invention relates to a stormwater treatment system including a two-chamber stormwater treatment container with bioretention capability. The stormwater treatment container includes a treatment chamber having a bottom, sidewall(s), and a top at least partially open to the atmosphere. The top may include a slab of water impermeable material having a substantially central opening through which plant material grows. The treatment container includes an overflow or bypass chamber having an inlet opening for receiving stormwater to be treated. Mounted adjacent the inlet opening within the bypass chamber is an overflow tray that directs stormwater to be treated into the treatment chamber and directs overflow into the bypass chamber. The treatment chamber includes filter media that may include a layer of mulch overlying a soil mixture that includes a combination of organic and non-organic material that supports the growth of live plant material in the filter media. An energy dissipation rock layer overlies the mulch layer. Embedded within the media is an underdrain pipe that receives the treated stormwater as it seeps through the media toward the bottom of the container. Treated stormwater passes through the underdrain pipe, through an underdrain pipe opening in the sidewall to the bypass chamber and in turn to a storm drain or sewer system or other type of discharge system or method. The treatment container may be positionable below ground level to receive stormwater through a curb inlet opening.

Stormwater enters the container through the curb inlet and falls onto the overflow tray positioned above a portion of the bypass chamber. The overflow tray includes a dam wall or weir wall. When the stormwater flows are high and in excess of the capacity to be treated by the filter media, the overflow/bypass overflows the dam and falls into the bypass chamber and, in turn, flows through the bypass outlet pipe(s). The bypass outlet pipe(s) is connected to an opening through the bypass chamber side walls to exit the bypass chamber without passing through the treatment chamber.

It is an object of the present invention to provide a stormwater bioretention treatment container having the capability of enabling stormwater entering at high flow rates in excess of treatment capacity to bypass the treatment chamber and filtration media. It is further an object of the present invention to provide a stormwater bioretention treatment container having two chambers, a treatment chamber and a bypass chamber.

Still further, it is an object of the present invention to have a stormwater treatment container with bioretention capability wherein the stormwater to be treated first flows onto an overflow tray positioned in the overflow chamber prior to falling onto the filter media within the separate treatment chamber. The tray includes a dam wall or weir wall. The tray receives untreated stormwater that, at high flow rates, overflows the dam or weir wall and allows the overflow to be directed into the bypass chamber.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a perspective view of a prior art stormwater bioretention filtration system;

FIG. 2 is an isometric perspective view of the treatment container of the present invention without the filter media within the treatment chamber;

FIG. 3 is an isometric perspective view of the treatment container without the top slab;

FIG. 4 is a top plan view of the treatment container shown in FIG. 2;

FIG. 5 is a top plan view of the treatment container of FIG. 4 without the top slab;

FIG. 6 is a front view of the treatment container with the front wall transparent;

FIG. 7 is a side view of the treatment container with the side wall transparent;

FIG. 8 is a top plan view similar to the view shown in FIG. 4 and showing the dimensions of a preferred embodiment;

FIG. 9 is a section view cut away showing the filter media within the treatment chamber and the position of the overflow tray in the overflow chamber;

FIG. 10 is a perspective view of an overflow tray having a curved weir;

FIG. 11(a) is a perspective view of an overflow tray with a straight weir; and

FIG. 11(b) is a close-up view of an “L-shaped” opening, for receiving a bolt, as shown in FIG. 11(a).

### DETAILED DESCRIPTION OF THE PREFERRED EMBODIMENTS

In describing preferred embodiments of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

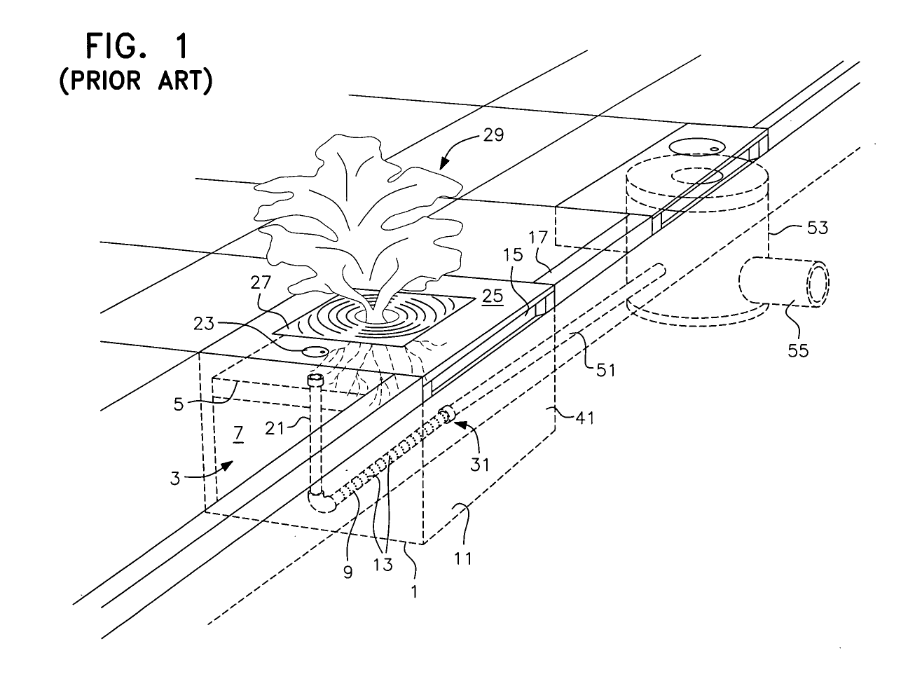

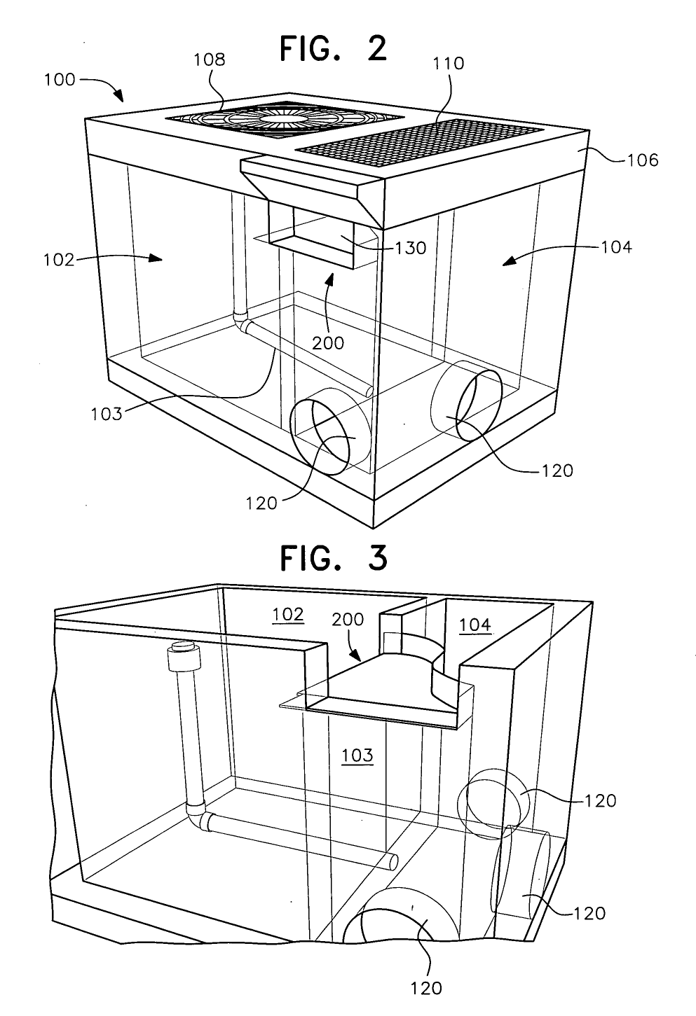

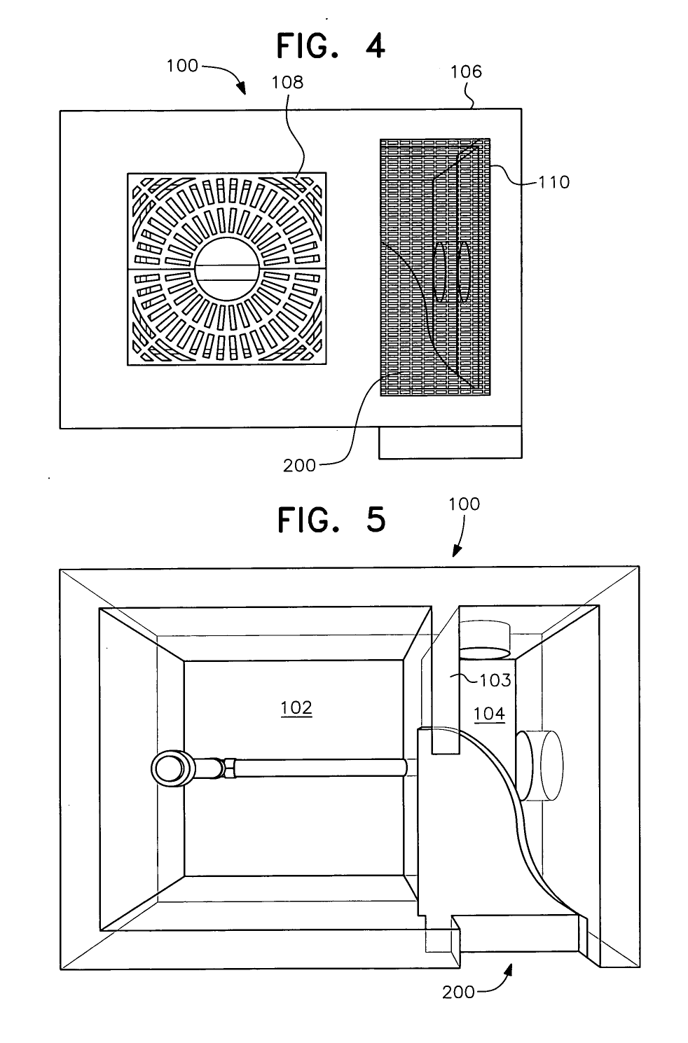

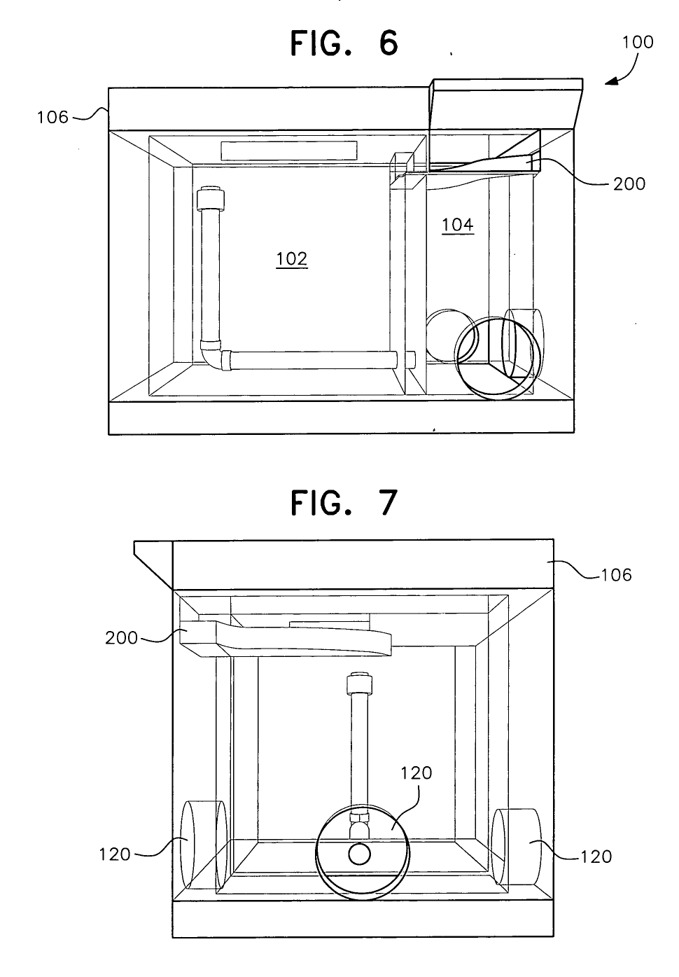

Referring now to the drawings and, specifically, FIG. 1, a prior art stormwater bioretention filtration system of the type disclosed in U.S. Pat. Nos. 6,277,274 and 6,569,321 (FIGS. 2 and 6, specifically) is depicted (hereinafter, the “Coffman patents”). This prior art system has been commercialized as the FILTERRA® stormwater bioretention filtration system by Americast, Inc. The prior art system includes a substantially water impermeable container 1, preferably of concrete, which holds filter media 3, including a mulch layer 5 overlying soil mixture 7 of the type described in the Coffman patents incorporated by reference herein. A stormwater underdrain pipe 9 is provided adjacent the bottom 11 having a plurality of openings 13 that receive the stormwater as it is filtered through the media. Incoming stormwater flows through, in this example, a cutout 15 in a curb 17 adjacent a roadway and the stormwater seeps through the filter media 3 into the underdrain pipe 9. Associated with the underdrain pipe 9 is a vertical clean-out pipe 21 (as described in the Coffman patents) that is accessible through a clean-out plate 23 positioned in the top slab 25 of the treatment container 1. The clean-out pipe is optional. Located substantially centrally in the top slab 25 is a tree grate 27 through which plant material, such as a plant or tree 29, can grow therethrough. The plant material 29, along with the filter media 7 that preferably comprises a non-organic matrix material and an organic matrix material including topsoil, provides for the filtering of the stormwater runoff to capture, remove and cycle pollutants through a variety of physical, chemical and biological processes as described in the Coffman patents incorporated by reference herein, as well as in the publication “An Advanced Sustainable Stormwater Treatment System” authored by Coffman et al., as found on the website www.filterra.com also incorporated by reference herein.

As shown in FIG. 1, the underdrain pipe 9 is connected through an underdrain pipe opening 31 in a side wall 41 to a drainpipe 51 that, in the example depicted, goes to a separate catch basin 53 prior to entering the storm drainpipe or sewer pipe 55. The use of a catch basin is optional. No bypass or overflow line is provided out of the container. When high stormwater flows are received, the high flow will merely pass on the street level into the catch basin 53 from the street.

The concrete container 1 and treatment media 7 as shown in FIG. 1 are below grade with the only features visible being the concrete top slab 25, the tree grate 27, the plant 29, and inlet opening 15 off of the curb 17.

The commercial FILTERRA® container size may vary from 4′×6′ to 6′×12′. The mulch layer is typically 3″ and the soil mixture height is typically 1.5′ to 3.5′.

Overflow/bypass arrangements for the FILTERRA® stormwater bioretention filtration system are also disclosed and described in U.S. Pat. No. 7,425,261, incorporated herein by reference.

Several systems for treating high flow rates and allowing such high flow rates to overflow/bypass the filter media are described. Overflow/bypass arrangements are also described in U.S. Pat. No. 7,833,412, having the same inventor and assignee of the present invention and also incorporated by reference herein.

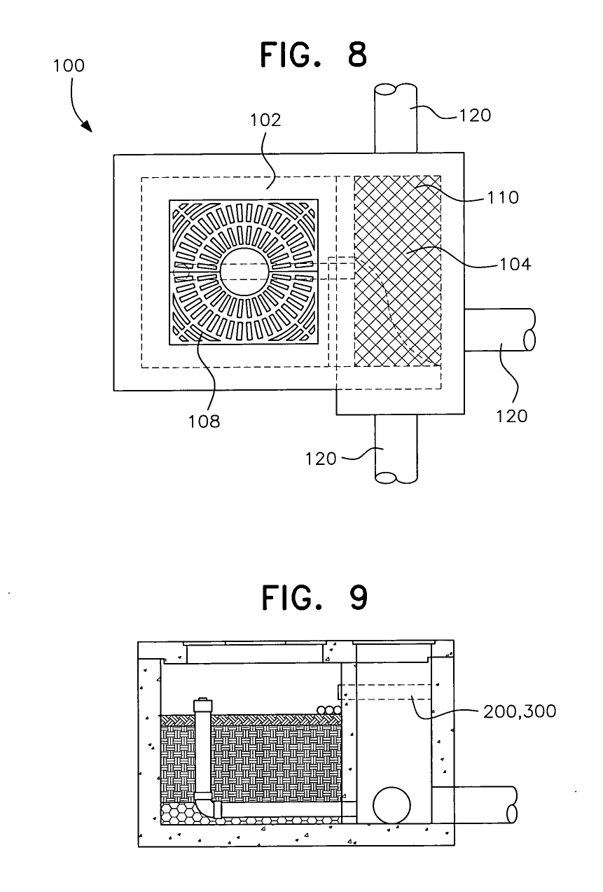

The present invention comprises a treatment container 100 having two chambers, a treatment chamber 102 and a bypass chamber 104 positioned in side-by-side relationship separated by a baffle wall 103. Within the treatment chamber 102 is filter media with a layer of mulch and an energy dissipation rock layer thereon as shown in FIG. 9. Below the filter media is underdrain stone. Embedded within the underdrain stone is an underdrain pipe connected through the wall 103 that exits into the bypass chamber 104. Associated with the underdrain pipe is an upright vertical clean-out pipe as is known in the art.

The treatment container includes a top slab 106 defining a tree grate opening with a tree grate 108 disposed therein. Cast iron or fabricated diamond-plate 110 covers the overflow or bypass chamber 104. One side of the top slab includes an inlet opening 130 adjacent a curb inlet. Disposed and fixed to the side walls of the bypass chamber 104 is an overflow tray 200 having an inlet opening adjacent the curb inlet and a discharge opening through the wall 103 to permit discharge of stormwater to be treated to fall into the treatment chamber 102 and to be treated by the filter media located therein.

The overflow tray 200, 300 is designed to be incorporated in the treatment container 100 to make the unit a stand-alone structure that can accommodate treatment and bypass. The overflow tray 200, 300 accommodates overflow within the treatment container rather than downstream using a separate curb inlet structure. This reduces project costs and simplifies the stormwater collection system.

The overflow tray 200, 300 will allow high flow to bypass the treatment chamber 102. High flow will be channeled directly to a bypass chamber 104.

A Filterra treatment container equipped with an overflow tray 200, 300 has two internal chambers 102, 104 rather than one. The first chamber 102 is the treatment chamber and the second chamber 104 is the bypass chamber. The treatment chamber 102 is configured similar to the treatment chamber in a traditional Filterra unit. The treatment chamber will preferably accommodate 3″ of mulch, 21″ of media, and 6″ of drain rock with an embedded underdrain pipe. Treatment rates and required media surface areas are the same as a traditional Filterra unit.

The second chamber, the bypass chamber 104, will serve a number of functions. The embedded underdrain pipe that serves the treatment chamber and carries treated stormwater to discharge will be connected to the bypass chamber 104 through the baffle wall 103 that separates the two chambers.

The main outlet pipe openings 120 that connect the Filterra unit to the storm sewer also connects to the bypass chamber 104. The main outlet pipes 120 carry treated flow and, if the influent stormwater flow exceeds the treatment flow rate, untreated bypass flow.

The main outlet pipes 120 may exit the bypass chamber from any of the three external bypass chamber 104 walls. The outlet pipe cannot exit the unit through the baffle wall 103 that separates the treatment chamber 102 from the bypass chamber 104. However, a Filterra unit with an overflow tray may be oriented to accommodate any plumbing configuration that may be required.

The bypass chamber 104 is also designed to accept untreated bypass flow from the overflow tray 200, 300 which is mounted over it. The overflow tray 200, 300 is located over the bypass chamber 104 and covers a portion of the bypass chamber 104. The overflow tray does not cover the entire bypass chamber. This allows for maintenance access to the bypass chamber and provides a flow path for overflow from the overflow tray.

The desired location of the curb inlet 130 and the required orientation of the main outlet pipes dictate the orientation and position of the Filterra unit with overflow tray. The overflow tray 200, 300 must be located over the bypass chamber 104 and adjacent to the throat 130 of the curb inlet.

The lid slab 106 of a unit equipped with an overflow tray 200, 300 will have a standard tree grate casting 108 over the treatment chamber and cast iron or fabricated diamond-plate covers 110 over the bypass chamber 104. The covers will allow maintenance personnel to access the overflow tray and bypass chamber. The tray may be accessed for inspection or to remove blockage resulting from large debris. The bypass chamber may be accessed to free a blocked outlet pipe or clean downstream pipes.

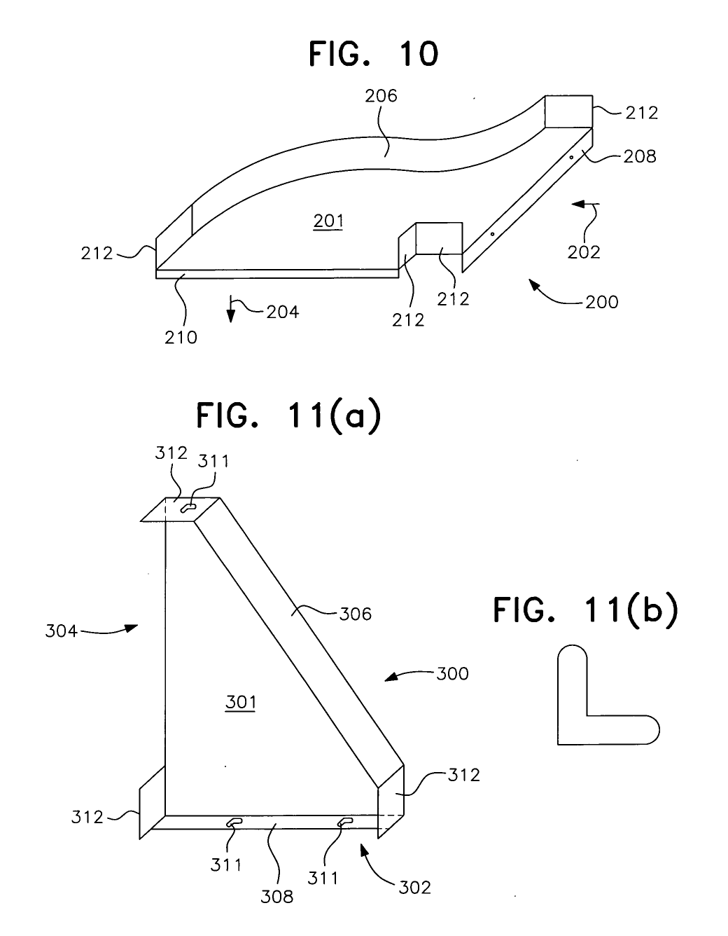

Two overflow trays are depicted as 200 and 300, FIGS. 10 and 11(a). Overflow tray 200, FIG. 10, has a curved weir 206. Overflow tray 300 has a straight weir 306. The overflow tray is configured to direct the treatment flow to the treatment chamber 102 and allow flow in excess of the treatment flow to bypass the treatment chamber. The overflow tray 200, 300 will consist of a horizontal tray floor or base plate 201, 301 cut in a substantially triangular shape. Vertical plates 212, 206 and 312, 306 will be welded or bent along the perimeter of the top of the base plate 201, 301 in strategic locations to contain the low flow and direct it to the treatment chamber through the discharge opening 204, 304. Vertical plates 208, 210, 308 will be welded, or unitary, along portions of the perimeter of the bottom of the base plate 201 in strategic locations to allow for attachment of the overflow tray 200 to the concrete bypass chamber vault. As is shown in the drawings, the vertical attachment plate arrangements for the curved weir embodiment (FIG. 10) and the straight weir embodiment (FIG. 11(a)) are slightly different, but each may be used interchangeably. The attachment arrangement pf FIG. 11(a) is preferred. In FIG. 10, the flange 208 is bent downward and circular openings or holes 211 are provided on the flange adjacent the inlet opening to attach to the bypass chamber wall. Other attachment openings would be provided in the flange 212 on the opposite side of the tray adjacent the discharge opening. In the FIG. 11 preferred embodiment, L-shaped openings 311 receive the bolts (not shown). In addition, the flange 308 adjacent the inlet opening is bent upward for attachment to the bypass chamber wall, thus slightly lowering the tray floor 301 with respect to the inlet opening within the bypass chamber.

The overflow tray 200, 300 is configured to deflect high velocity flow entering the treatment chamber. Vertical side plates at the overflow tray inlet prevent gutter flow from entering the treatment chamber directly. Most flow will deflect off one or more of the side plates before entering the treatment chamber. This reduces the tendency for incoming flows to scour the media bed.

The tray is preferably designed to be attached within the concrete vault or bypass chamber with three bolts as shown by the L-shaped bolt openings in FIG. 11(a). This attachment arrangement is also preferably used to attach the tray of FIG. 10 to the bypass chamber. It should be recognized that the trays of FIGS. 10 and 11(a) can be attached in other ways and the invention is not limited to any one mode of attachment.

As shown in FIGS. 11(a) and 11(b), two bolt openings 311 and bolts (not shown) are used to attach the flange along the leading edge of the tray to the vault or chamber just under the inlet throat. The remaining bolt opening 311 is used to attach the flange on the opposite side of the tray to the vault baffle wall 130. The tray will be sealed to the vault using flexible caulk.

The Filterra treatment container unit with overflow tray 200, 300 is designed to accept gutter flow. The Filterra unit with overflow tray may be located along a grade to accept gutter flow from one direction (up gradient) or in a sag to accept flow from two directions. The gutter flow enters the curb inlet, passes through the inlet throat, and into the overflow tray. The configuration of the overflow tray directs treatment flow either left or right, depending upon the application, into the treatment chamber. Treatment flow is delivered to the surface of the mulch layer for full treatment through the mulch and media column. Flow in excess of the treatment flow is bypassed over the weir 206, 306 on the back side of the tray into the bypass chamber.

The overflow tray will be fabricated from ¼-inch aluminum or steel plate. The horizontal base plate or tray floor will measure preferably about 26″×36″ unless it needs to accommodate a longer or smaller curb inlet opening, in which case the dimensions can be changed. One corner will be cut at a diagonal to allow for a greater weir length and access to the outlet chamber with the tray in place. The side plates that contain the flow on the top of horizontal base plate are all preferably 4 inches high. The bottom flanges on the overflow tray will preferably be equipped with L-shaped holes to accept bolts to fasten the tray to the concrete vault. All joints will be continuously welded to provide a sturdy, water-tight structure.

Although the weir is preferably four inches high, it may vary and could, for example, be three inches to six inches. The height above the weir to the bottom of the top slab may vary and could be three to four inches, up to eight to ten inches. The curb inlet could be wider and the inlet of the overflow tray could be substantially greater, as much as six feet wide.

The tray can be bolted or otherwise secured into the bypass chamber, such that it slopes at preferably ¼ inch per foot towards the treatment chamber.

The foregoing is considered as illustrative only of the principles of the invention. Further, since numerous modifications and changes will readily occur to those skilled in the art, it is not desired to limit the invention to the exact construction and operation shown and described, and, accordingly, all suitable modifications and equivalents may be resorted to, falling within the scope of the invention.

What is claimed is:

1. A stormwater treatment system comprising a treatment container having a treatment chamber for receiving filter media and a bypass chamber separated by a baffle wall, said baffle wall defining a discharge opening between said treatment chamber and said bypass chamber, said bypass chamber including an inlet opening for receiving stormwater to be treated,
an overflow tray positioned within said bypass chamber and in fluid communication between said inlet opening and said discharge opening, said overflow tray for receiving stormwater through the inlet opening, for discharging stormwater through said discharge opening into said treatment chamber, and for enabling high stormwater flow directly into said bypass chamber,
said overflow tray including a tray floor having a tray inlet area positioned adjacent said inlet opening, a tray discharge area positioned adjacent said discharge opening, and a weir wall extending upwardly from said tray floor, wherein stormwater to be treated enters the inlet opening, falls onto the overflow tray and water to be treated flows out of the discharge opening into the treatment chamber where it is filtered by the filter media, and wherein high flow rates bypass the treatment chamber by overflowing the weir wall and into the bypass chamber.

2. The stormwater treatment system of claim 1, wherein said treatment chamber includes an underdrain pipe including openings to receive treated stormwater and extending through said baffle wall in fluid communication with said bypass chamber.

3. The stormwater treatment system of claim 2, wherein said bypass chamber includes outlet openings to enable treated and untreated stormwater to be discharged from the bypass chamber.

4. The stormwater treatment system of claim 1, wherein said baffle wall discharge opening and said bypass chamber inlet opening are disposed substantially 90° apart.

5. The stormwater treatment system of claim 1, wherein said overflow tray floor is substantially a right triangular shape in plan view with said tray inlet area and tray discharge area adjacent right-angle legs of the triangular shape, and said weir wall is disposed substantially along the hypotenuse of the triangular shape.

6. The stormwater treatment system of claim 5, wherein said weir wall is a straight wall defining a triangle.

7. The stormwater treatment system of claim 5, wherein said weir wall is curved.

8. A stormwater treatment system comprising a treatment chamber formed from side walls defining a bottom, at least a partially open top, and a baffle wall having a baffle wall discharge opening, a bypass chamber formed from bypass chamber side walls defining a bottom, at least a partially open top, and said baffle wall, said bypass chamber including an inlet opening for receiving stormwater to be treated,
an overflow tray positioned within said bypass chamber and including a tray inlet area in fluid communication with the bypass chamber inlet opening, a tray discharge area in fluid communication with the baffle wall discharge opening, and a weir wall to enable overflow fluid communication between the tray and the bypass chamber,
said treatment chamber receiving a filter media including a soil mixture of organic and non-organic material for treating stormwater that may pass through the filter media, an underdrain pipe located within the filter media in proximity to said bottom and exiting the treatment container through an opening in the baffle wall into the bypass chamber, said underdrain pipe including perforations to receive treated stormwater.
